(19) United States
(12) Patent Application Publication
(10) Pub. No.: US 2011/0183835 A1
(43) Pub. Date: Jul. 28, 2011

(54) ADSORBER ELEMENT AND METHOD FOR PRODUCING AN ADSORBER ELEMENT

(75) Inventors: Juergen Sauer, Muenchen (DE); Belal Dawoud, Winterberg (DE); Stefanie Chmielewski, Frankenberg (DE); Hendrik Van Heyden, Augsburg (DE); Heike Klaschinsky, Coelbe (DE)

(73) Assignee: Viessmann Werke GmbH & Co.KG, Allendorf (DE)

(21) Appl. No.: 12/998,319

(22) PCT Filed: Oct. 2, 2009
(86) PCT No.: PCT/DE2009/001370

§ 371 Date: Apr. 11, 2011

(30) Foreign Application Priority Data
Oct. 10, 2008 (DE) 10 2008 050 926.4

(51) Int. Cl. B01J 20/28; B01J 20/10; B01J 20/08; B01J 20/18; B01J 20/20; B01J 20/32; B01J 37/02; B82Y 30/00

(52) U.S. Cl. 502/60; 502/400; 502/407; 502/414; 502/405; 502/416; 502/100; 977/902

(57) ABSTRACT

The invention relates to an adsorber element and to a method for the production thereof, comprising a carrier material (1) on which adsorbent particles (3) are arranged as the adsorber layer using a binding agent (2). According to the invention, the adsorber layer comprises inorganic fibers (4) and the binding agent (2) is designed as a colloid.

The invention relates to an adsorber element according to the preamble of Patent Claim 1 and method for manufacturing an adsorber element according to the preamble of Patent Claim 15.

An adsorber element of the type defined in the introduction is used, for example, in heat pumps on a so-called adsorbent basis (for example, silica gel, activated carbon or zeolite [then called molecular sieve basis]). Such adsorbents (molecular sieves) are usually characterized in that they take up refrigerants (water, for example) in a reversible reaction and release them again on exposure to heat. This is due to the pronounced pore structure of this class of materials, which also includes zeolites. Heat is released in absorption of the refrigerant, and conversely, heat is needed to release the refrigerant. The heat effect in the respective reaction, whether refrigerant adsorption (the adsorbent releases heat) or refrigerant desorption (the adsorbent takes up heat) can be utilized in heat pumps, as mentioned above. For this purpose, it is necessary for the heat to be efficiently transportable to or from the adsorbent. Likewise, the adsorbent must be accessible to the refrigerant molecules, in other words, its pore structure must not be clogged or even blocked.

Adsorbents are usually crystalline solids whose particle size is usually in the range of a few micrometers. Good binding of these adsorbent particles to a material such as aluminum or copper having a very good thermal conductivity is advantageous for their use in a heat pump. Since adsorbent particles do not usually adhere to metal, it is necessary to use adhesion promoters (binder materials) which glue the particles to one another and to the metal. These adhesion promoters must meet two criteria. They should not hinder the adsorption of refrigerant into the adsorbent and in general they should not interfere with the function of the heat pump. They should also be made of environmentally tolerable and economically acceptable materials.

The heat pump operates under a pure refrigerant vapor pressure at different temperatures. Increasing the pressure prevailing in the heat pump leads to a loss of power of the heat pump due to the presence of inert gases, which can ultimately lead to complete failure. For this reason, the adsorbent layer should not release any gases during a desired lifetime of 15 years, in other words, in particular the adhesion promoter (binder material) that is used must not release any gases.

According to DE 33 47 700 C2, the use of metal meshes (metal wool) to form zeolite molded bodies is provided in order to apply adsorbent layers to metal. Zeolite suspensions are cast with a binder in metal mesh and dried, whereby the metal mesh can be attached to metal walls of a heat pump, for example. However, this method is described as being inadequate by the same applicant in DE 44 05 669 A1. Thus, the metal mesh with zeolite becomes detached from the metal walls in cyclic stresses.

DE 44 05 669 A1 describes a method for coating metals with zeolite suspensions, using commercial high-temperature binder materials, for example, “GunGum” from the company Holstas, as the binder material. This approach has at least three disadvantages: “GunGum” is a material based on water glass, which is an alkali silicate. However, those skilled in the art know that the water stability of alkali layers is poor. Hydrolysis of the alkali silicate occurs in long-term loading, in which water condenses and heat acts on the binder material and/or the alkali silicate in cycles. This is associated with a decline in strength and embrittlement of the silicate, so the binding ability declines and there may be degradation of the adsorbent layer. Another problem is the alkalinity of alkali silicates, because many adsorbents, including the family of aluminophosphates, silicoaluminophosphates and silicon-rich zeolites can be mentioned, are attacked and/or dissolved by alkaline substances. In particular the molecular sieve (adsorbent) known as “FAM” from the company Mitsubishi, which is especially suitable for use in a heat pump, is attacked by alkaline substances and therefore also by “GunGum.” Finally, the carbonate impurities which often occur in these materials are a third problem when using “GunGum” or other alkali silicates as a binder material. These impurities originate from the fact that alkaline substances adsorb carbon dioxide, which is present in small quantities in air, when they come in contact with air and then form the corresponding alkali carbonate in this process. In long-term exposure of a layer produced with such a binder, carbon dioxide may be split off from the alkali carbonates thereby formed, thus increasing the pressure within the heat pump and resulting in a loss of power.

Different problems occur if other high-temperature binders not based on alkali silicates are used. For example, the high-temperature type 8 Sauereisen cement from the company SeppZeug GmbH does not contain any alkali silicates but instead contains magnesium oxide, magnesium phosphate and zirconium silicate. However, if this material is used as a binder, shrinkage cracks occur massively. Shrinkage cracks are generally caused by a decline in the volume of the solidifying suspension due to the evaporation of fluid and may often be observed when loamy river banks dry out, for example. The adsorbent layer has a very unstable adhesion to aluminum sheeting and falls off immediately with light vibrations. The same problem occurs with the high-temperature binder Ceramabond from the company Kager GmbH. This binder, like the type 8 Sauereisen cement, does not contain any alkali silicates but instead contains corundum in a fine particle size in particular. Experiments have shown that adsorbent layers produced using this binder also have numerous shrinkage cracks and flake away from the metal immediately under thermal stress (160° C.)

In principle, the performance, in other words, in particular the stability of molecular sieve layers, is improved by using glass wool nonwovens, as also described in DE 44 05 669 A1. For this purpose, a glass wool nonwoven is applied directly to the metal and then bonded using the molecular sieve/binder suspension. One disadvantage of this approach is that such a glass wool nonwoven can be used only with readily accessible geometries of the metal body.

Additional patents and publications are concerned with producing zeolite layers on various substrates, whereby organic adhesion promoters are used, or the zeolite layer is grown on a substrate in a tedious process.

Organic adhesion promoters have the inherent disadvantage that outgassing can occur due to degradation reactions of the organic substances within the heat pump over long periods of time and can then impair the function of the heat pump. This happens against the background that the layers are exposed to temperatures above 150° C. in cyclic operation of the heat pump, and organic substances tend to decompose at these temperatures.

According to WO 2002/045847 A2, a zeolite layer produced by using organic polymer binders is provided, for example.

Methods by which zeolites are grown directly on substrates are described in JP 63291809 A, JP 59213615 A, DE 693 20 195 T2 and DE 103 09 009 A1. For this purpose, aluminum oxide substrates (JP 63291809 A), glass (JP 59213615 A), ceramic (DE 103 09 009 A1) or even metals or metal alloys, such as aluminum or steel (DE 693 20 195 T2), for example, are placed in a reactive synthesis solution, in which the substrates may be partially dissolved. The dissolved substrate can then be incorporated into the resulting zeolite crystals, which remain adhering directly to the substrate that has not yet dissolved.

With these methods, thin, very well-adhering zeolite layers are obtained. The disadvantage is that the production method cannot be used with all substrate materials in general and is very complex. Molded bodies to be coated (the substrates) must be placed in reactors and typically kept at high pressures and temperatures over a period of several days. Especially untreated and reactive aluminum, such as that which is very advantageous for this production method, however, is undesirable in heat pumps because it may lead to so-called hydrogen corrosion over a long period of time. In this type of corrosion, water reacts with aluminum, forming aluminum hydroxide and/or aluminum oxide hydroxide and/or aluminum oxide and hydrogen. However, the formation of hydrogen in a heat pump is highly undesirable because this gas increases the operating pressure of the heat pump.

The object of the present invention is to improve an adsorber element and/or a method for producing an adsorber element of the type described in the introduction.

This object is achieved in the present case according to the characterizing features of Patent Claim 1 with an adsorber element of the type defined in the introduction. According to this method, the characterizing features of Patent Claim 14 solve this problem.

With the present invention, it is possible to coat bodies of any shape (in particular metal bodies) with adsorbent particles in a permanent and stable manner. Because of the binder materials used, there is no outgassing during operation of the heat pump.

According to the invention, metal bodies in particular are coated according to the invention by applying a liquid, preferably aqueous suspension, and then performing a drying operation. The suspension contains adsorbent particles, fibers and a colloidal binder in addition to the liquid phase,.

Colloids (from the Greek kolla “glue” and eidos “form, appearance”) refer to particles or droplets that are finely distributed in another medium (solid, liquid or gas), the dispersion medium. The individual colloid is typically between one nanometer and ten micrometers in size. Colloids usually exhibit Brownian motion if they are mobile (for example, in a liquid dispersion medium).

Both the fibers and the colloidal binder are selected from the class of inorganic, inert or largely inert substances, so there cannot be any chemical reactions and/or outgassing during operation of the heat pump.

Colloidal silicon oxides or colloidal aluminum oxides/hydroxides, for example, are used as colloidal binders for bonding adsorbent particles.

Fibers are used to impart elasticity and strength to the layer and to prevent shrinkage cracks because the latter may be formed in particular when drying the suspension.

Since the layer is continuously exposed to changes in temperature, stresses occur between the various materials that are present, in other words, metal, adhesion promoters, fibers and adsorbent. These substances have different thermal expansion coefficients and therefore undergo different changes in volume and length when heated, which results in the aforementioned stresses. To achieve permanent strength of the layer, this means that the layer must be elastic within certain limits—it must be able to “breathe.” To obtain a certain relaxation ability of the layer when working with relatively brittle materials such as glass, the corresponding binder material used is preferably used in fiber form.

The maximum possible bending of a fiber until breakage depends to a significant extent on the diameter of the fiber. The thinner a fiber, the more it can be bent without breaking and the more elastic as a whole will be the layer in which these fibers are embedded. In other words, flexible materials that are elastic to a certain extent can also be produced using brittle oxidic materials such as glass, for example, if they are processed as fibers. For example, a drinking water glass is a brittle, fragile object but glass wool has a very high flexibility. A single glass wool fiber can be wound onto a roll, for example, without breaking.

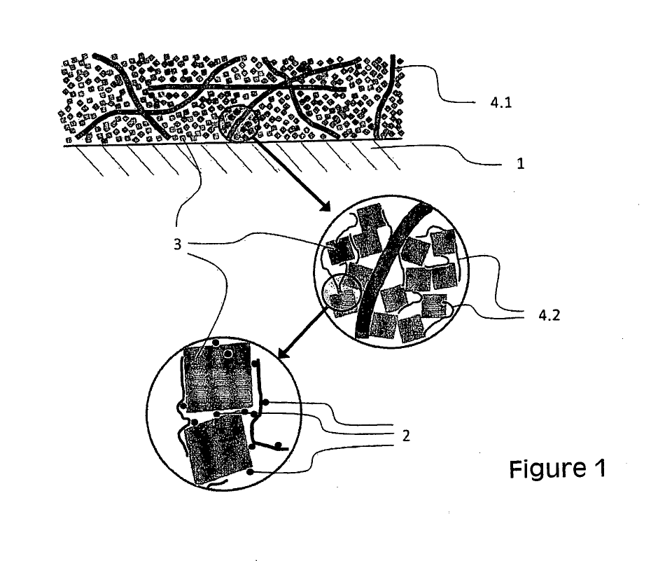

According to the invention, especially advantageous fibers of various orders of magnitude may be used. Larger fibers impart stability and elasticity over great distances of the layer, whereas smaller fibers bind the individual adsorbent particles to one another and to the larger fibers and the substrate over small distances (see also FIG. 1, which illustrates schematically the structure of such a layer).

The use of fiber materials offers two additional advantages. First, a layer cross-linked by fibers is less susceptible to trouble. For example, if the layer becomes detached from the metal at one location due to strong mechanical stress, it nevertheless remains adhering to the substrate surface as a whole because other locations can still ensure adequate adhesion.

The second advantage lies in the thermal conductivity of the layer. In addition to the adhesion and elasticity, this is crucial for successful implementation of the overall concept. If fibers having a good thermal conductivity are used, the thermal conductivity of the entire layer is increased.

A colloidal binder is necessary as an adhesive in order to bind fibers, adsorbent particles and the substrate and/or metal surface to one another on a molecular level. It has the advantage in comparison with conventional adhesives that it need not be organic (commercially available adhesives, for example, Uhu, epoxy resin, Pattex, etc., consist of organic substances with the disadvantages mentioned above) nor can it completely or even partially bond the pores of the adsorbent. Complete bonding of the adsorbent pores should be avoided for use in a heat pump because this would prevent the adsorbent from adsorbing or desorbing the refrigerant.

One possible disadvantage of the technique presented here for creating a partially elastic layer with the help of fibers is the preferred orientation of fibers that might be created due to directional shearing forces during the application process. Such a preferential orientation may result in the occurrence of shrinkage cracks during the process of drying the suspension. In general, the adsorbent layer can be reinforced mechanically only in the direction of the longitudinal axis of the fibers. However, since the layer is subjected to stresses anisotropically—in all directions in space—during thermal stress, a random distribution of the fibers would be preferred. Such a random distribution can be largely achieved by spraying the suspension onto the respective substrate, which leads to weak, irregular shearing forces. Fibers can no longer be oriented directionally in this way. A second method lies in adding a gas-forming substance, which is added to the suspension and is present in the layer in a homogeneous distribution during the process of drying the suspension, leading to a randomly distributed orientation of the fibers due to the formation of gas bubbles. If gas bubbles emerge from the liquid suspension before it dries, they result in an irregular and randomly distributed turbulence in the suspension, so that the fibers that are present are distributed irregularly, as desired. Formation of the gas bubbles additionally leads to loosening of the dried layer, while the cavities and channels that develop facilitate the diffusion of water molecules, but on the other hand they make the transport of heat within the layer difficult.

The gas-forming substance is to be selected from the group of reactive or volatile substances, so that after the process of drying the suspension, no more gas, which could influence the function of the heat pump, is formed.

Additional advantages and details of the invention include:

1. Firmly adhering layers can be obtained by thoroughly mixing ground fibers of an average length of approximately 100 micrometers and a diameter of 5-12 micrometers with adsorbent powder and adding a colloidal binder based on aluminum oxide/silicon oxide. The resulting aqueous suspension is mixed again thoroughly and then applied to any substrate. After a drying process, these layers will adhere to different materials with a hydrophilic surface, such as copper, glass, aluminum or porcelain.

2. Firmly adhering layers with an increased porosity can be obtained as described in point 1 if the suspension containing fibers, adsorbent particles and colloidal binders, some hydrogen peroxide and a catalyst that decompose hydrogen peroxide, for example, iron(III) chloride, is added. Hydrogen peroxide breaks down according to the following equation:

H₂O₂→H₂O+½O₂

The resulting oxygen escapes and, during drying, forms pores approximately 50 micrometers in size.

Iron(III) chloride is given here as an example of a catalyst that decomposes hydrogen peroxide, but there are a number of other suitable catalysts that may be selected, depending on the specifics. Additional examples that can be mentioned include MnO₂, colloidal MnO₂, MnCl₂, Fe(OH)₂, Fe(OH)₃, colloidal Fe(OH)₃. The use of colloidal forms of certain transition metal oxides/hydroxides may be especially advantageous because they have a high catalytic activity for the decomposition of H₂O₂, so they need be added only in very small quantities and because they cannot penetrate into the adsorbent pores, given a sufficient size of the catalyst particles, which could lead to a loss of efficacy.

3. Firmly adhering layers having an improved thermal conductivity can be obtained as described in point 1 if fibers having a good thermal conductivity, such as carbon fibers, are used as the fibers.

4. Firmly adhering layers having a further improved thermal conductivity can be obtained as described in point 1 by adding carbon nanotubes (CNTs) in an amount by weight of a few percent and distributing them homogeneously in the suspension. Hydrophilized multiwall CNTs (carbon nanotubes) are preferably used.

5. Firmly adhering layers having an improved thermal conductivity and an increased porosity can be prepared as described in point 4 if some hydrogen peroxide and some iron(III) chloride are additionally added to the suspension as the decomposition catalyst, but iron(III) chloride is only one example of such a decomposition catalyst (see also point 2).

For the sake of thoroughness, the following prior art, which is even more remote, is also referenced:

DE 10 2006 028 372 A1 describes a heat transfer agent in which a plurality of fibers can be attached to a wall with a thermally conductive adhesive foam. According to one embodiment, the individual fibers are covered with a sorption agent. This document does not disclose an adsorber element and/or a method by which the adsorber layer is applied in the form of a suspension.

DE 10 2005 000 022 A1 discloses a sorbent molded body and a method for producing and using same. The powder used and/or the granules used are not in the form of a layer in this approach but instead are in the form of a so-called aggregate material (mix of solid particles mixed loosely together or pressed firmly together or caked) arranged inside a cage.

The inventive adsorber element as well as the method for producing the inventive adsorber element are explained in greater detail below on the basis of a few examples.

### EXAMPLES

All of the substrates were carefully cleaned and degreased before being coated. The aluminum substrates used were degreased with pickling degreaser.

All the adsorbent layers in described in Examples a) through e) adhere firmly to the aluminum sheets used and do not separate from the sheet metal even under thermal load. For the first test of the strength achieved, the coated sheet metal is subjected to repeated thermal shocks. For this purpose, they were placed in an oven at approximately 160° C. and then immediately dipped in a bucket filled with ice water. Then the procedure was repeated up to three times. In additional experiments, the, layers were brought to 120° C. with the help of a special test setup, and then cooled to 20° C. after 10 minutes. In heating, dry air was passed over the samples, and in cooling, moist air was passed over the samples. After 15,000 cycles of this type, the samples did not have any stability problems.

The average layer thickness of the layers thus created was approximately 350 to 450 micrometers.

The adsorber content of all the layers produced in the examples, including the comparative examples, was 70% (percent by weight) based on the completely hydrated adsorbent.

a) Producing a firmly adhering molecular sieve layer on aluminum sheet metal using FAM molecular sieve from the company Mitsubishi: The hydrated FAM molecular sieve (9 g) was mixed thoroughly with 2.5 g ground carbon fibers with a diameter of ˜7 micrometers (=μm) and an average length of approximately 100 micrometers, then 4 g deionized water was added. After adding 4.3 g aqueous colloidal silicon oxide coated with aluminum oxide with a solids content of 30% (percent by weight), the pasty mixture was homogenized by rubbing. The resulting suspension was spread on aluminum sheeting. The suspension was dried at room temperature. The dried layer was heated in an oven at 150° C. for 6 to 12 minutes.

b) Producing a firmly adhering molecular sieve layer on aluminum sheeting using DDZ-70 molecular sieve from UOP: The procedure described under a) was repeated. Instead of FAM molecular sieve from the company Mitsubishi, DDZ-70 molecular sieve from the company UOP was used.

c) Producing a firmly adhering molecular sieve layer using FAM molecular sieve from the company Mitsubishi and glass fibers on aluminum sheeting: The procedure described under a) was followed but instead of carbon fibers, ground glass fibers with a diameter of 6 micrometers and a length of approximately 100 micrometers were used.

d) Producing a firmly adhering molecular sieve using FAM molecular sieve from the company Mitsubishi and carbon fibers with an increased porosity on aluminum sheeting: The procedure described under a) was followed, except that before applying the suspension to aluminum sheeting, enough hydrogen peroxide and molar iron(III) chloride solution were added so that the finished layer had an adequate porosity. Then after adding hydrogen peroxide, the suspension was applied within 10 minutes.

e) Production of a firmly adhering molecular sieve layer using FAM molecular sieve from the company Mitsubishi and carbon fibers plus carbon nanotubes on aluminum sheeting: To produce these layers, the method described under a) was followed, but instead of 0.4 g water, 0.4 g of an aqueous solution containing carbon nanotubes (CNTs) was added. The CNTs were hydrophilized for this purpose.

f) Production of a firmly adhering molecular sieve layer using FAM molecular sieve from the company Mitsubishi on glass, copper and porcelain substrates: The method used was the same as that described in a), but the following substrates were coated: standard microscope slides for microscopy, copper plate and porcelain. The coatings adhered well to the respective substrates and could be detached only with strong mechanical action (for example, using a chisel). Also, they would not detach from the substrates even under thermal shock. The layers produced on the copper plate were brought to a temperature of 160° C. and then immersed in ice water without resulting in any visible change in the layers. In the case of the glass and porcelain substrates, this treatment resulted in partial rupturing of the ceramic objects. However, the molecular sieve layer remained adhering to the fragments.

g) Comparative example, using DDZ-70 molecular sieve from the company UOP and high-temperature binder Sauereisen cement No. from the company SeppZeug GmbH: DDZ-70 molecular sieve (4.25 g) and 1.83 g Sauereisen cement powder and 5 mL deionized water were mixed together thoroughly, and then 4.4 g of this mixture was applied to a degreased aluminum sheet with an area of 50 cm². Numerous clearly discernible shrinkage cracks could be seen in this layer.

h) Comparative example, using FAM molecular sieve from the company Mitsubishi and high-temperature binder Sauereisen cement No. 7 from the company SeppZeug GmbH: The procedure followed was the same as that described under g), but instead of the DDZ-70 molecular sieve, the FAM molecular sieve was used. Again, numerous clearly discernible shrinkage cracks could be seen in the layer.

i) Comparative example, using DDZ-7 molecular sieve from the company UOP and Ceramabond 569 high-temperature binder from the company Kager Industrietechnik GmbH: This binder is a paste. To achieve a binder content of 30% in the layer to be produced, the solids content of the binder was determined by weighing before and after the set-up process. It was found to be 83%. To produce a layer, 4.25 g DDZ-70 molecular sieve was moistened with approximately 1 g water and mixed thoroughly with 2.19 g Ceramabond 569 in a mortar. Of this mixture, 4.4 g was applied to an area of approximately 50 cm² aluminum sheeting. After drying, numerous shrinkage cracks were discernible. The layer separated partially from the sheet metal when shaken slightly.

j) Comparative example, using FAM molecular sieve from the company Mitsubishi and high-temperature binder Ceramabond 569 from the company Kager Industrietechnik GmbH: The procedure followed was the same as that described in Example h). In contrast with Example i), shrinkage cracks are discernible only with a magnifying glass, but the layer is only insignificantly more stable than that produced in Example i) and it falls off after only slight vibration.

### LIST OF REFERENCE NUMERALS

1 carrier material

2 binder material

3 adsorbent particles

4 inorganic fibers

4.1 “long” fibers (approximately 100 micrometers in length)

4.2 “short” fibers (less than 10 micrometers in length)

1. An adsorber element comprising a carrier material (1) on which adsorbent particles (3) as an adsorber layer are arranged with a binder material (2), wherein the adsorber layer applied as a suspension contains inorganic fibers (4) and the binder material (2) is embodied as a colloid.

2. The adsorber element according to claim 1, wherein the colloidal binder material (2) is formed from an inorganic inert substance.

3. The adsorber element according to claim 1, wherein the colloidal binder material (2) consists optionally of silicon oxide, aluminum oxide or aluminum hydroxide.

4. The adsorber element according to claim 1, wherein optionally zeolite, silica gel, aluminum or activate carbon is used as the adsorbent particles (3).

5. The adsorber element according to claim 1, wherein the adsorber layer has a thickness of 300 to 500 micrometers.

6. The adsorber element according to claim 1, wherein the adsorber layer contains adsorbent particles (3) in an amount by weight of more than 50%, preferably 70%, especially preferably 80% to 85%.

7. The adsorber element according to claim 1, wherein the adsorber layer applied as a suspension contains a gas-forming substance.

8. The adsorber element according to claim 7, wherein the gas-forming substance is formed optionally from a reactive and/or volatile substance.

9. The adsorber element according to claim 1, wherein the fibers (4) are formed from an inert substance.

10. The adsorber element according to claim 1, wherein the fibers (4) are embodied in different lengths.

11. The adsorber element according to claim 1, wherein the fibers (4) have a length of 80 to 120 micrometers.

12. The adsorber element according to claim 1, wherein the fibers (4) have a diameter of up to 12 micrometers.

13. The adsorber element according to claim 1, wherein the fibers (4) have good thermal conductivity, preferably as carbon fibers or glass fibers or carbon nanotubes.

14. The adsorber element according to claim 1, wherein the carrier material (1) formed from metal, in particular aluminum.

15. A method for producing an adsorber element, adsorbent particles (3) being applied as an adsorber layer to a carrier material (1) using a binder (2), wherein the adsorber layer is applied to the carrier material (1) as a suspension of the colloidal binder material (2), the adsorbent particles (3) and inorganic fibers (4) to be dried.

16. The method according to claim 15, wherein the suspension is optionally sprayed or painted onto the carrier material (1) or applied by immersion.

17. The method according to claim 15, wherein hydrogen peroxide and a catalyst that decomposes hydrogen peroxide are added to the suspension.

18. The method according to any claim 15, wherein carbon nanotubes are added to the suspension in a homogeneous distribution and in an amount by weight of a few percent.
